(19) United States
(12) Patent Application Publication
(10) Pub. No.: US 2011/0153680 A1
(43) Pub. Date: Jun. 23, 2011

(54) AUTOMATED DOCUMENT CLASSIFICATION AND ROUTING

(75) Inventors: Mark S. Rolla, Chicago, IL (US); Travis H. Tran, Skokie, IL (US)

(73) Assignee: Brinks Hofer Gilson & Lione, Chicago, IL (US)

(21) Appl. No.: 12/646,636

(22) Filed: Dec. 23, 2009

(51) Int. Cl. G06F 17/30

(52) U.S. Cl. 707/803; 707/E17.046

(57) ABSTRACT

A system for classifying documents receives parsable data that defines an information object associated with a document. The information object defines an ID and document characterization information. The system determines a database record associated with the ID by searching through a database for a record associated with the Id. The system stores at least some of the document characterization information in the record.

### BACKGROUND

Document classification and routing are essential components of any organization. Generally, documents, such as correspondence from a government agency, are classified and then routed to individuals responsible for processing the information contained in the document. For example, in a law firm that handles intellectual property matters, documents typically communicated from a patent office are classified by a docketing department and then routed to attorneys or agents responsible for handling applications associated with the documents.

To classify a document, an operator typically reads the correspondence to determine the nature of the correspondence. Information in the correspondence is then manually entered into a rules based tracking and calendar system, such as a docket system, which may track deadlines for events related to the correspondence. This can be a time consuming process and prone to error. Alternatively, the correspondence can be analyzed via optical character recognition (OCR) software, but this would also be time consuming and prone to errors.

After docketing the information, the documents are routed to the individuals above. In the past, the only way to communicate such documents was via a mail carrier. However, today these documents may be communicated via networks, such as the Internet. In some instances, hundreds or thousands of documents can be communicated within a few minutes by downloading the documents from a data server.

In either case, however, the process of routing the documents within the organization to individuals responsible for dealing with the subject matter of the documents is a largely manual process. For example, a mailroom operator may have to print all the documents downloaded from the data server, then separate and sort the printed documents. The documents may then be routed to personnel trained to review and classify the documents and enter the data into the tracking system. Next, the operator may have to search a database to identify individuals responsible for processing the documents, such attorneys or agents. Finally, the operator must communicate the documents to the responsible individuals. For a large organization processing a high volume of documents on a daily basis, this can be a time-consuming process, which ultimately leads to delay in the delivery of the documents.

### BRIEF DESCRIPTION OF THE DRAWINGS

FIG. 1 illustrates an exemplary document classification and routing system;

FIG. 2 is a flow chart of exemplary operations that may be performed by the document classification and routing system of FIG. 1;

FIGS. 3A and 3B are exemplary web pages for retrieving information from a patent application and information retrieval (PAIR) system;

FIG. 4 illustrates exemplary extensible markup language (XML) code that is processed by the document classification and routing system of FIG. 1;

FIG. 5 illustrates an exemplary combined document file;

FIG. 6 illustrates an exemplary document that is processed by the document classification and routing system of FIG. 1;

FIG. 7 illustrates an exemplary message that is generated by the document classification and routing system of FIG. 1; and

FIG. 8 illustrates a general computer system, which may represent any of the computing devices referenced herein.

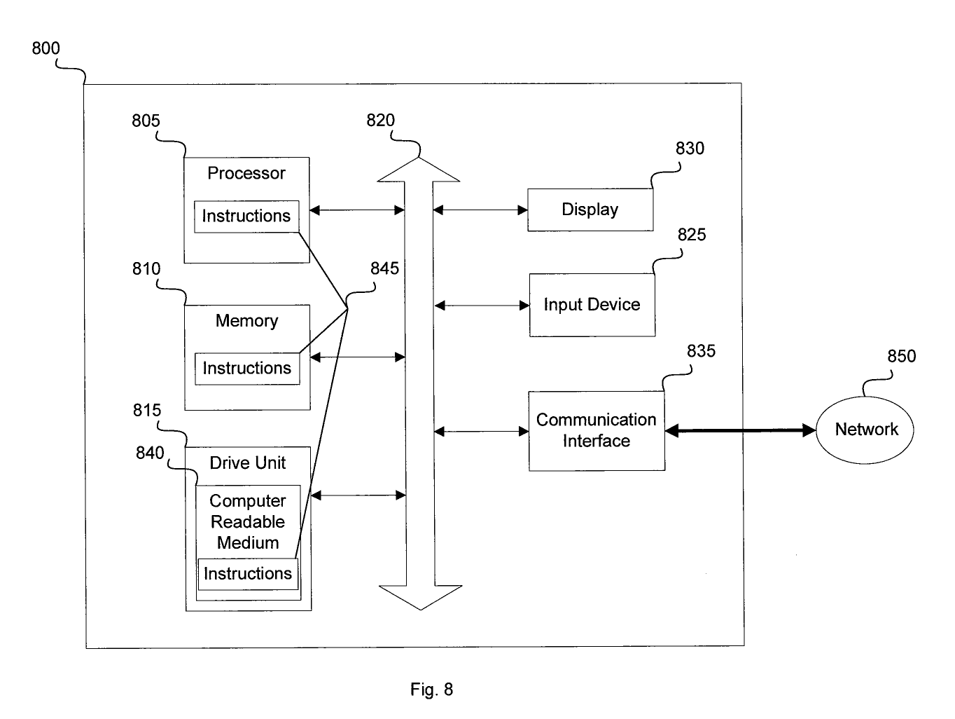

### DETAILED DESCRIPTION

The embodiments below describe an exemplary document classification and routing system. Generally, the document classification and routing system is configured to receive a parsable data file that includes characterization information that characterizes a listing of documents associated with one or more concerns such as a group of patent applications. The characterization information is then stored in a file tracking database record associated with a given concern.

The document classification and routing system is also configured to automatically receive a group of documents provided by a data sever that are associated with the parsable data. The document classification system determines an individual responsible for processing the document(s) and then generates and communicates a message to the individual, notifying the individual about the document's existence and/or provide a copy thereof.

Although described as a combined system for characterizing and routing documents, one of ordinary skill will understand that the system and operations described below may be performed separately by the same system or by independent systems.

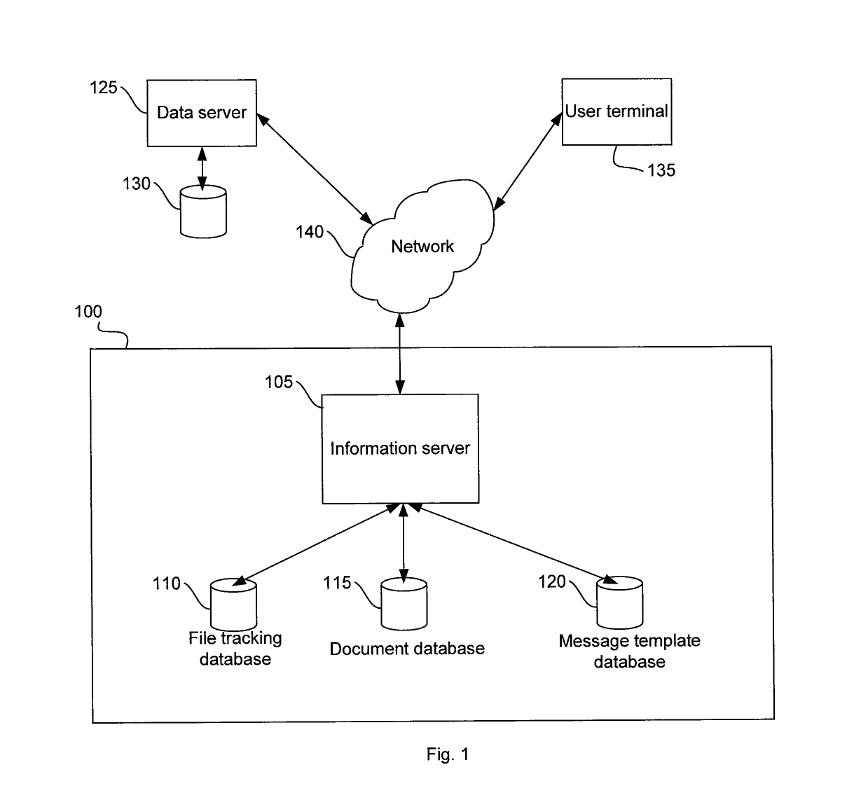

FIG. 1 illustrates an exemplary document classification and routing system 100, herein after referred to as the system 100. The system 100 includes an information server 105 in communication with a file tracking database 110, a document database 115, and a message template database 120. The various components of the system 100 may reside on a single computer or be distributed among several computers interconnected by a communication network.

Also shown in FIG. 1 are a data server 125 and a user terminal 135 that communicate with the system 100 via a network 140. The information server 105, data server 125, and user terminal 135 may correspond to an Intel®, AMD®, or PowerPC® based computer or a different computer. The information server 105, data server 125, and user terminal 135 may include an operating system, such as a Microsoft Windows®, Linux, or other Unix® based operating system, or a different operating system. The information server 105, the data server 125, and the user terminal 135 may be configured to communicate with one another or with other computers via a public, private, wired or wireless, or combination thereof, network 140.

The user terminal 135 may correspond to a personal computer, a workstation, a smart phone, or a different device operable to send and receive messages communicated over a network 140. For example, the user terminal 135 may be operable to execute an email program, an instant messaging program, a browser program, or a different communication program configured to send and receive messages to other devices.

The data server 125 is configured to communicate documents associated with a particular concern, such as a property item or other concern in which documents are maintained. The data server 125 is also configured to communicate a parsable data file, such as an XML file, that includes data which describes the documents communicated. The data server 125 may include a web server operable to communicate the documents and parsable data file via a web page. The data server 125 may also be configured to operate as a database server, such as a structured query language (SQL) server, or a different server. The data server 125 is operable to receive a request to serve documents stored in a database 130 in communication with the data server 125 and/or a parsable data file based thereon, and to communicate the requested documents and/or parsable data file to the requestor.

In one implementation, the data server 125 corresponds to a patent application information retrieval (PAIR) system operated by the United States Patent and Trademark Office (USPTO) that is configured to receive a request to communicate correspondences and correspondence listings associated with a patent application. For example, one or more customer numbers associated with a group of patent applications may be communicated to the PAIR system, and the PAIR system may communicate a correspondence listing associated with the group of patent applications along with documents that correspond to electronic versions of the correspondence.

The correspondence listings communicated by the data server 125 may be communicated in a user-friendly format, such as a hypertext markup language (HTML) that is viewable within a browser. The user-friendly format may enable downloading the documents associated with the listings. The documents may correspond to electronic versions of the correspondence and may include graphical representations of the correspondences rather than data that defines the actual text of a correspondence. The documents may be stored in a portable document format (PDF) or a different format, such as TIFF.

The correspondence listings may also be communicated as a parsable data file, such as an extensible markup language (XML) file that defines information objects that specify information about the concern and information about the documents associated with the concern.

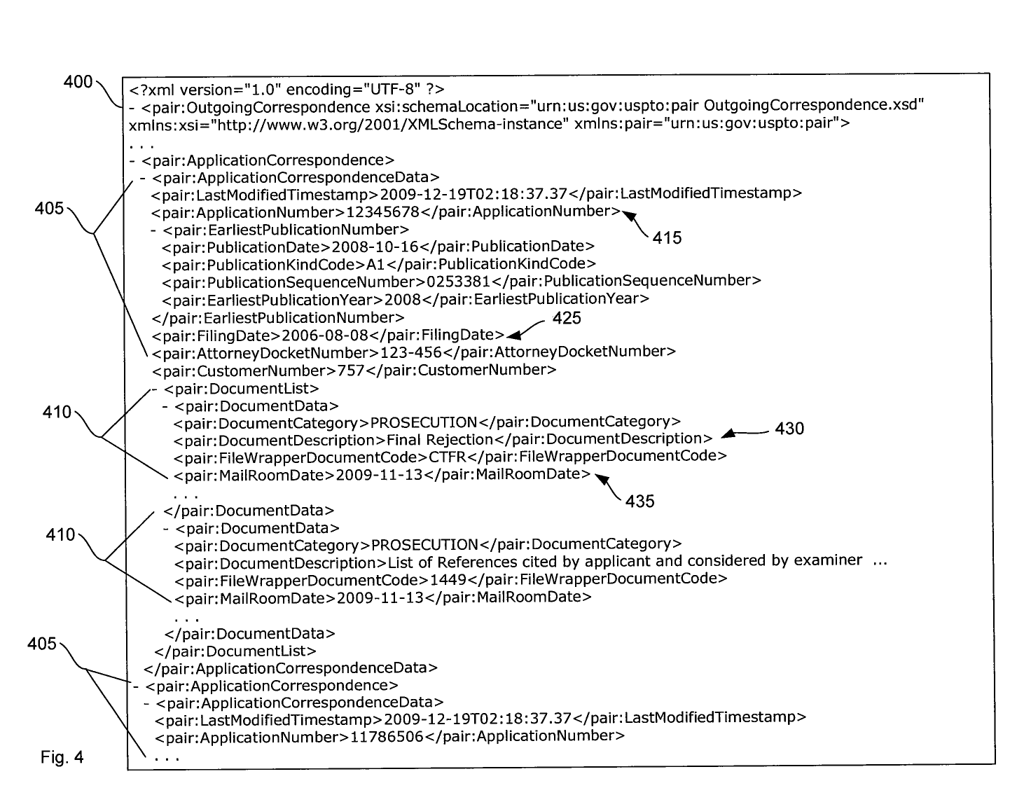

FIG. 4 illustrates an exemplary parsable data file 400 associated with a concern, such as a patent application. The parsable data file 400 includes information objects that define header information 405 and an information object that defines document characterization information 410. The header information 405 may include an ID 415 or identification information that identifies the particular concern. For example, the ID 415 associated with a patent concern may correspond to a patent application serial number.

The document characterization information 410 may specify information that characterizes a particular correspondence associated with the concern. For example, the document characterization information 405 for a patent application may indicate the mailing date 435 of a particular correspondence along with a description 430 of the correspondence.

Referring back to FIG. 1, in some implementations, a single request may be utilized to retrieve all the documents associated with a group of concerns. For example, a common ID associated with a group of concerns, such as a customer number that is associated with a group of patent applications, may be communicated to the data server 125. This enables retrieving all the documents associated with the concerns, where each document is an electronic version of a correspondence associated with the concern that was either sent to or received from the data server 125.

The request may include a date range, or other constraint, operable to limit the documents communicated to those documents associated with correspondences communicated within the specified date range. For example, a request may be sent on a daily basis and may specify that only documents generated on that day or the previous day be communicated.

The documents may be communicated in a combined document file. For example, for a patent concern, a single PDF file that includes all the office actions and responses associated with the patent may be communicated. Additionally or alternatively, the combined document file may include all the office actions associated with a group of patent concerns, or all the office actions communicated within a date range associated with the group of patent concerns.

The information server 105 may include code, logic, and/or other circuitry that enables the reception and routing of information from the data server 125 to the user terminal 135. The information server 105 may be configured to communicate a common ID associated with a group of concerns to retrieve information associated with the group of concerns. For example, the information server 105 may communicate a customer number to a PAIR system to retrieve information associated with all the patents that are associated with the customer number. Alternatively, as described below, an operator may communicate the common ID and then download information associated with the group of concerns. The operator may then communicate the information to the information server 105.

The information server 105 may also be configured to receive, from the data server 125, a parsable data file and a combined document file associated with the common ID. In some implementations, the information server 105 is configured to store information in the parsable data file into a file-tracking database 110 and to extract documents from the combined document file and to store the extracted documents in the document database 115. In alternative implementations, the operations of receiving the parsable data file and the combined document may also be performed as separate independent operations.

The information server 105 is also configured to locate different concerns specified through the parsable data file and to compare header information and other information associated with a given concern with information associated with the same concern stored in the file-tracking database 110 of the system 100. For example, the information server 105 may search for a record in the file-tracking database 110 with an ID that matches the ID specified in the header information of a given concern, such as a patent application serial number. In addition, for a parsable data file associated with a group of patent applications, the information server 105 may further compare the filing date, correspondence information, and other information associated with a patent application listed in the parsable data file with patent application information stored in a file-tracking database 110.

In some instances, the information server 105 may not locate a record corresponding to header information in the parsable data file or may locate the record, but determine that some of the information in the record does not match information in the header information and/or document characterization information. In some implementations, the information sever 105 may then automatically present an image of the document along with the documents associated header information, document characterization information, and/or record information to an operator via an interface. The interface may request that the operator validate the information associated with the document as being correct. In other words, the operator may be asked to determine whether the information in the document matches the header information, document characterization information, and/or record information. For example, the operator may be presented with the document and the data as entered in the file-tracking database and asked whether they match. Alternatively, the user may be presented with the document and asked to enter the requisite data from the document. The system may then compare the operator's entry with that which was automatically determined. Any mis-matches may then be forwarded to the same operator or a different operator for review.

The information server 105 is also configured to search the file-tracking database 110 to identify an individual associated with a particular concern. The information server 105 may also be configured to generate a message to the individual notifying the individual of a particular documents existence and to communicate the message to the individual. In some implementations, the information server 105 is configured to retrieve the document from the document database 115 and to attach or otherwise associate the document with the message.

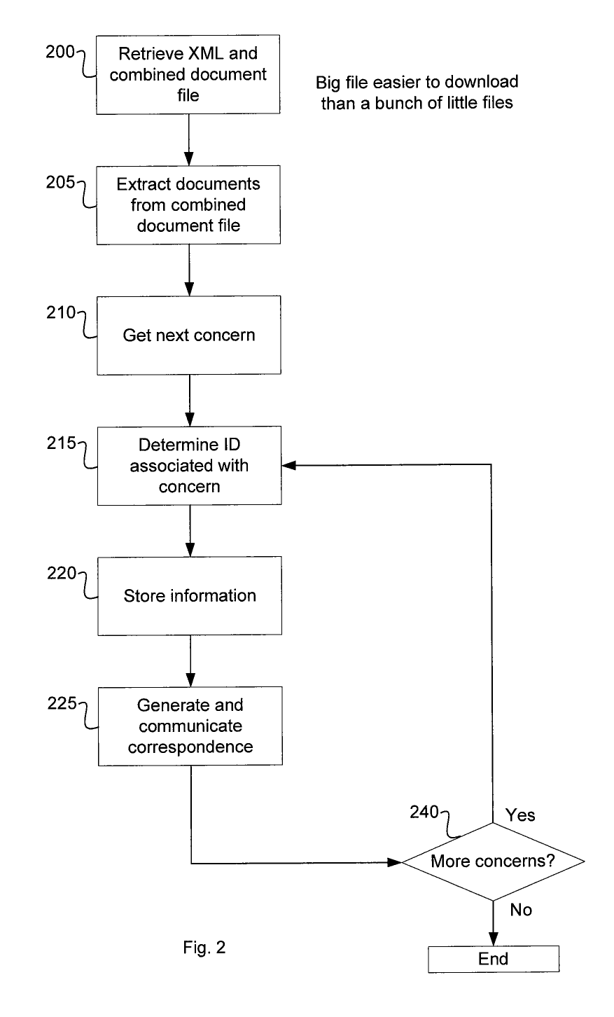

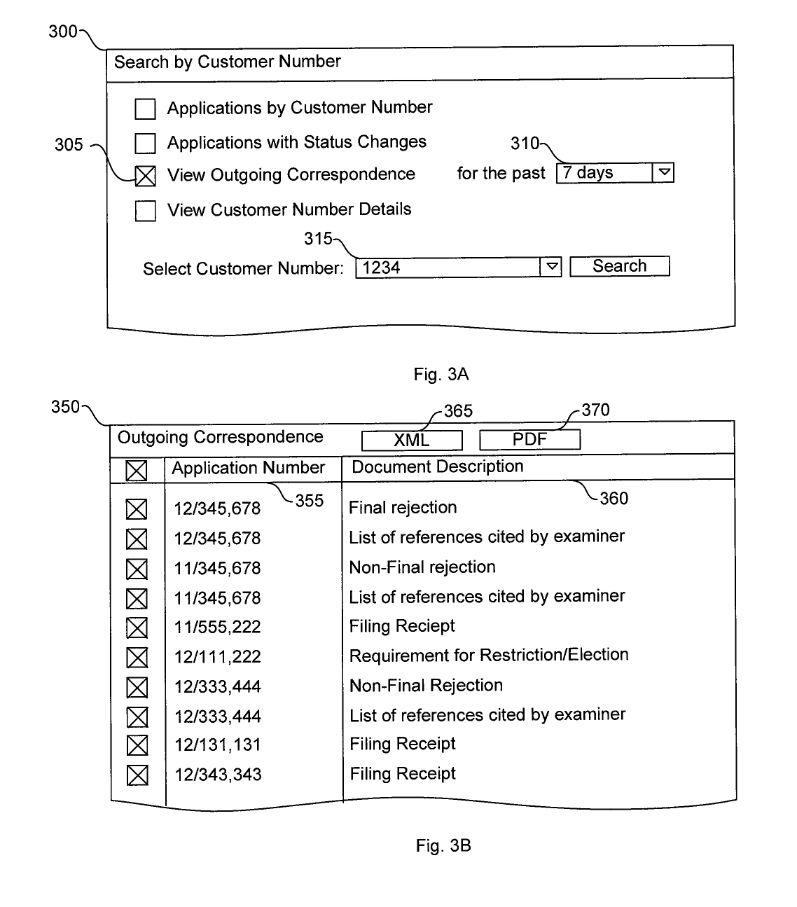

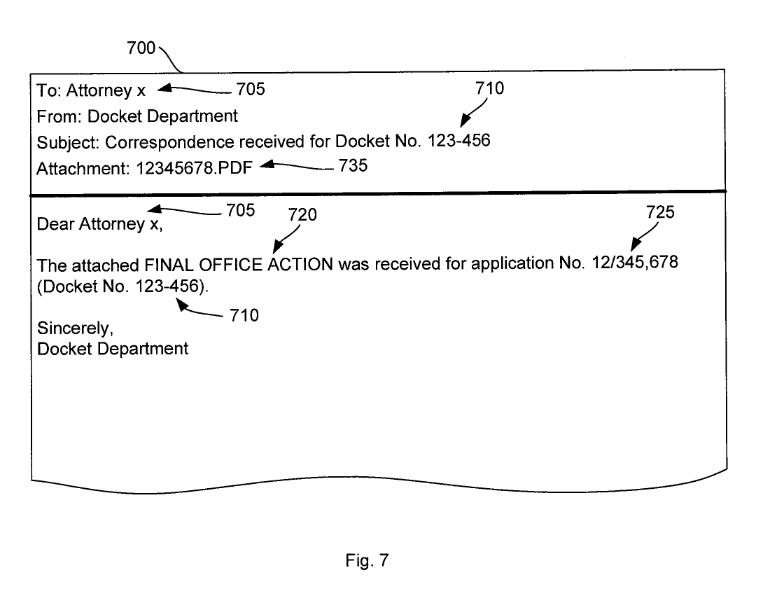

FIG. 2 is a flow chart of exemplary operations that may be performed by the system 100. The operations are more clearly understood with reference to FIGS. 3-7. One of ordinary skill will understand that the operations of characterizing and routing documents are not dependent on one another and may be performed separately. Furthermore, the operations may be implemented on independent systems.

At block 200, operations for retrieving a parsable data file and a combined document from a data server 125 (FIG. 1) may be performed. These operations may be performed manually or automatically.

For example, an information server 105 (FIG. 1) may automatically communicate a common ID, or otherwise communicate a request, associated with several concerns to a data server 125 (FIG. 1). After receiving the common ID, the data server 125 may communicate a parsable data file 400 (FIG. 4) to the information server 105. The parsable data file 400 may correspond to an XML formatted file that includes a group of information objects associated with the group of concerns. The parsable data file 400 may include information objects that specify header information 405 (FIG. 4) and document characterization information 410 (FIG. 4) associated with each concern. Each information object that defines document characterization information 410 may specify a document description 430 (FIG. 4) and a document mailing date 435 (FIG. 4) associated with a document that is associated with the concern.

In some implementations, the data server 125 also communicates a combined document file that includes documents associated with the group of concerns along with the parsable data file 400. In other implementations, a separate request for the combined document file is communicated to the data server 125.

In the context of a patent application, an operator may navigate to a PAIR web site operable to communicate a patent application search web page 300, as illustrated in FIG. 3A. Referring to FIG. 3A, the operator may specify a desired correspondence type 305, a date range 310, and a customer number 315 associated with the desired correspondence. For example, via the desired correspondence type 305, the date range 310, and the customer number 315, the operator may request all outgoing correspondence communicated in the last seven (7) days associated with customer number 1234.

Upon receiving the search request, the PAIR web site may communicate a correspondence selection web page 350. The correspondence selection web page 350 may include an application number column 355 that lists patent application serial numbers associated with patent applications for which a correspondence was communicated during the specified date range, and a document description column 360 that includes a description of each correspondence communicated. A PDF download button 370 and an XML download button 365 enable the operator to download a combined document file that includes copies of the selected correspondence and an XML file that describes the selected correspondence, respectively. The downloaded combined document file and XML file may then be communicated to the information server 105.

In some implementations, the operator may search for correspondence associated with patent applications on a daily basis, which may result in overlapping cases when a date range greater than one (1) is specified. In this case, the operator may only select those correspondence uploaded within the days of interest, such as previous business day and any intervening non-business days.

At block 205, individual documents are extracted from the combined document file. To facilitate extraction, the combined document file may include document separation information that enables locating the beginning and end of a given document. The combined document file may also include document identification information that enables determining an ID associated with a document extracted from the combined document file.

In some implementations, the individual documents are stored to a document database 115 (FIG. 1) for later retrieval. In other implementations, the individual documents are extracted from the document database when they are needed.

There may be instances in which multiple documents are associated with a given ID. For example, several correspondences may have been generated and uploaded for a given patent application on the same day. In some implementations, the information server 105 may treat these documents as a single document. In other words, a single document may be utilized to represent all the correspondence associated with a given application uploaded on a given day.

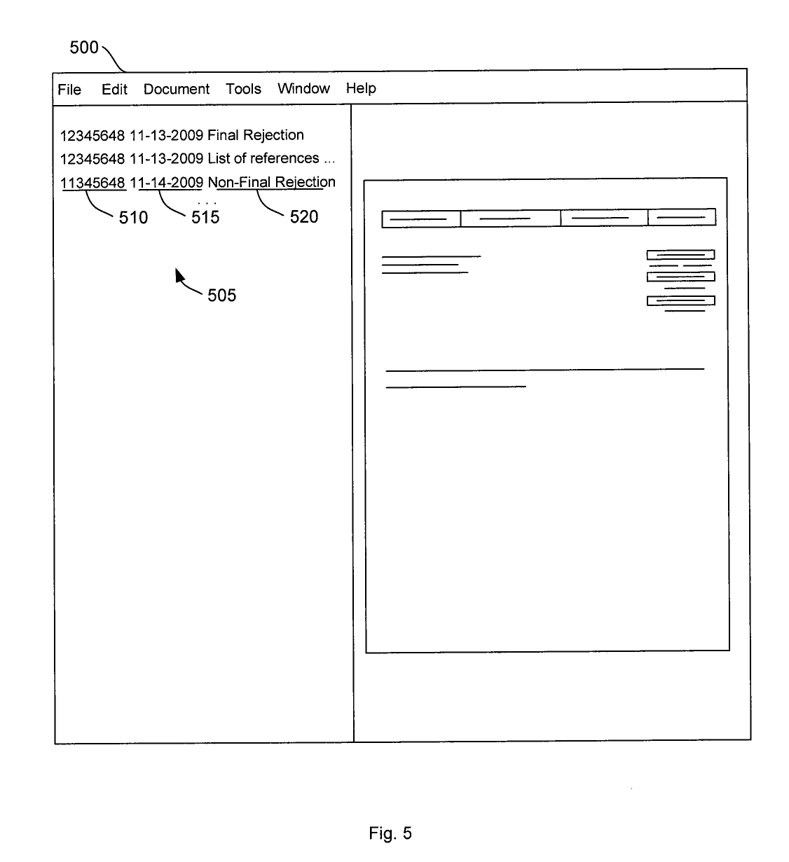

An exemplary combined document file 500 communicated from a PAIR system is illustrated in FIG. 5. The exemplary combined document file 500 corresponds to a PDF file that includes the correspondence selected above. Bookmarks 505 in the PDF indicate the first page of a given correspondence. The bookmarks 505 specify the application number 510, mailing date 515, and description 520 of a given correspondence.

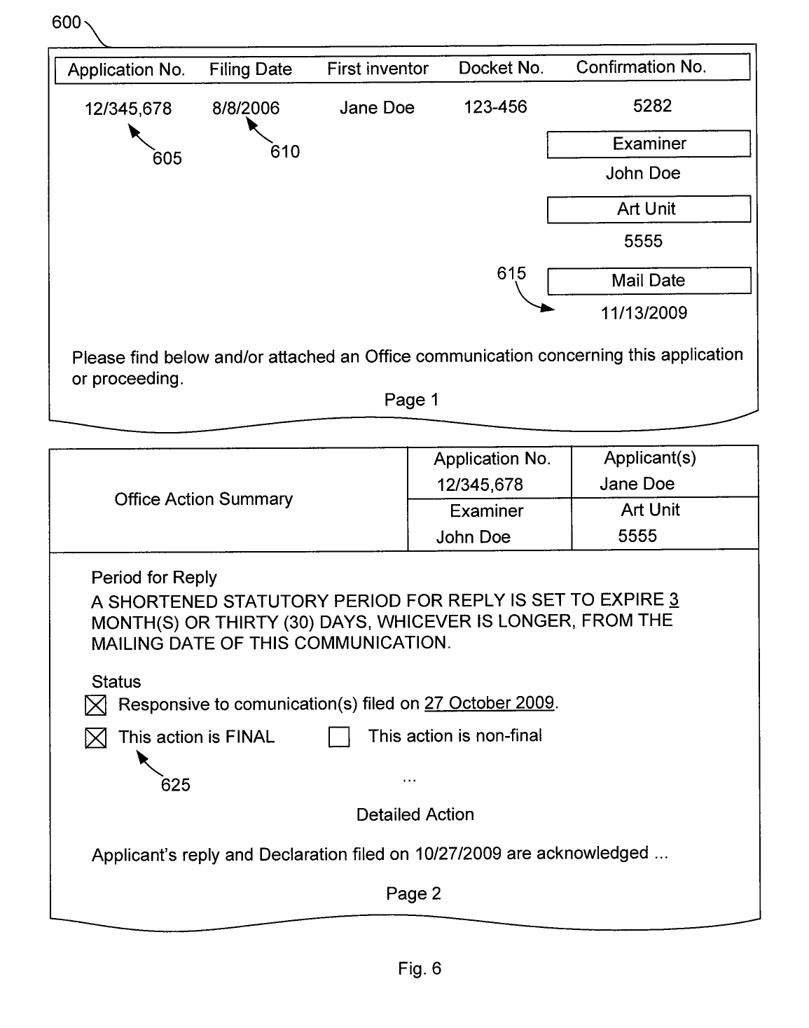

FIG. 6 illustrates an exemplary document that may be extracted from a combined document file associated with a patent application. Referring to FIG. 6, the document 600 may correspond to a first page and second page of a USPTO office action. The first page of the document may indicate information, such as an application number 605 and a filing date 610 associated with the application, as well as a mailing date 615 associated with the document. The second page of the document 600 may indicate a document type and status 625.

Returning to FIG. 2, at block 210, the parsable data 300 file may be searched to locate an information object that specifies the header information 305 associated with a given concern. In some implementations, software operating on the information server may be configured to search for a line of text that signifies the beginning of the header information 405 (FIG. 4). For example, referring to FIG. 4, the information server may search for an instance of the text “ApplicationCorrespondenceData,” which identifies the first line of an information object that specifies header information 405 for a given patent application.

At block 215, an ID associated with a particular concern may be determined from the header information 405. For example, referring to FIG. 4, the ID associated with a patent application may correspond to the application serial number 415 of the patent application.

At block 220, information for a given concern may be stored to the file-tracking database 110 (FIG. 1). For example, the information server 105 may search for the first instance of an information object that occurs after the header information 405 that specifies document characterization information 410 associated with the concern. For example, referring to FIG. 4, the information server may search for the first instance of the text “DocumentData” that occurs after the text “ApplicationCorrespondenceData,” which corresponds to the first line of an information object that defines document characterization information 410.

The information server 105 may then locate a record in the file-tracking database 110 associated with the ID. Information specified by the document characterization information 410 may be stored at the record location. For example, referring to FIG. 4, the text “Final Rejection” from the document description field 430 and the text “2009-11-13” from the mailing date field 335 may be extracted from the document characterization information 410 associated with the patent application and stored in corresponding fields of the record associated with the application serial number.

In some instances, multiple instances of document characterization information 410, corresponding to multiple documents, may be associated with a given ID. For example, several correspondence may have been generated and uploaded for a given patent application on the same day. In this case, information associated with these instances may also be stored in the file-tracking database 110. In some implementations, the information server 105 may treat these instances as a single document. The information server 105 may characterize these instances in accordance with some or all of the document characterization information associated with the instances.

In some implementations, the information stored in the record is compared with the header information 405 and/or other information associated with a given concern that is specified in the parsable data file 400. If the stored information does not match the information in the parsable data file 400, the record may be flagged as such. In this case, further processing by the system 100 with respect to the concern may cease.

At block 220, a message to an individual associated with a given ID may be generated to notify the individual that correspondence has been received. The name and contact information associated with the individual may be specified in the record in the file tracking database 110 associated with the ID. The contact information may include an email address, phone number, or other contact information associated with the individual.

Next, the message format is determined. The format of the message may be based at least in part on the document type specified in the document characterization information 410. For example, the information server 105 may search a message template database 120 (FIG. 1) for a message template tailored to communicate the receipt of a final rejection of a patent application. The information server 105 may replace fields of the message template with at least some of the information stored in the record associated with the ID. The information server 105 may also replace fields associated with the recipient of the message with the name of the responsible individual determined above. Then the message may be communicated to the user identified in the message. For example, the message may be communicated via email to a user terminal 135 (FIG. 1).

FIG. 6 illustrates an exemplary message 800 that may be communicated at block 220. In this case, the exemplary message 800 is utilized to notify an individual associated with a patent application that a final office action has been received. As shown, the exemplary message 800 may be addressed to the identified individual 805. The subject line of the exemplary message 800 may include a reference to a docket number 810 that may have been stored in the record located above. The body of the message may indicate a document description 820 associated with the document that was received, such as “Final Office Action.” The document description may correspond to the document description 430 specified in the document characterization information 430. A patent application number 825 may also be provided. The patent application number 825 may correspond to the ID 415 determined from header information 405. Other information specified in the header information 405, the document characterization information 410, and/or the record associated with the ID may also be provided.

In some implementations, the document 835 associated with the ID may be attached to the message. For example, the information server 105 may search through the document database 115 (FIG. 1) for a document 835 associated with the ID. The information server may then attach the document 835 to the message 800. Information specified in the message may be related to the substance of the document. For example, the document may correspond to the final office action that is the subject of the message.

At block 240, the parsable data file 400 may be searched to determine whether there is another information object that specifies header information 405. If such an information object exists, the process repeats from block 215. Otherwise, the operations end.

FIG. 6 illustrates a general computer system 800, which may represent the information server 105, the data server 125, the user terminal 135, or any other computing devices referenced herein. The computer system 800 may include a set of instructions 845 that may be executed to cause the computer system 800 to perform any one or more of the methods or computer-based functions disclosed herein. The computer system 800 may operate as a stand-alone device or may be connected, e.g., using a network, to other computer systems or peripheral devices.

In a networked deployment, the computer system 800 may operate in the capacity of a server or as a client-browser device in a server-client user network environment, or as a peer computer system in a peer-to-peer (or distributed) network environment. The computer system 800 may also be implemented as or incorporated into various devices, such as a personal computer or a mobile device, capable of executing a set of instructions 845 (sequential or otherwise) that specify actions to be taken by that machine. Further, each of the systems described may include any collection of sub-systems that individually or jointly execute a set, or multiple sets, of instructions to perform one or more computer functions.

The computer system 800 may include a memory 810 on a bus for communicating information. The file tracking database 110, document database 115, and/or message template database 120 may be stored in the memory 810. In addition, code operable to cause the computer system to perform any of the acts or operations described herein may be stored in the memory 810. The memory 810 may be a random-access memory, read-only memory, programmable memory, hard disk drive, or any other type of memory or storage device.

The computer system 800 may include a display 830, such as a liquid crystal display (LCD), a cathode ray tube (CRT), or any other display suitable for conveying information. The display 830 may act as an interface for the user to see the functioning of the processor 805, or specifically as an interface with the software stored in the memory 810 or in the drive unit 815.

Additionally, the computer system 800 may include an input device 825, such as a keyboard or mouse, configured to allow a user to interact with any of the components of system 800.

The computer system 800 may also include a disk or optical drive unit 815. The disk drive unit 815 may include a computer-readable medium 840 in which one or more sets of instructions 845, e.g. software, can be embedded. Further, the instructions 845 may perform one or more of the operations as described herein. The instructions 845 may reside completely, or at least partially, within the memory 810 and/or within the processor 805 during execution by the computer system 800. The memory 810 and the processor 805 also may include computer-readable media as discussed above.

The computer system 800 may include a communication interface 835 that enables communications via a network 850. The network 850 may include wired networks, wireless networks, or combinations thereof. The communication interface 835 network may enable communications via any number of communication standards, such as 802.11, 802.17, 802.20, WiMax, cellular telephone standards, or other communication standards.

Accordingly, the method and system may be realized in hardware, software, or a combination of hardware and software. The method and system may be realized in a centralized fashion in at least one computer system or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The method and system may also be embedded in a computer program product, which includes all the features enabling the implementation of the operations described herein and which, when loaded in a computer system, is able to carry out these operations. Computer program in the present context means any expression, in any language, code or notation, of a set of instructions intended to cause a system having an information processing capability to perform a particular function, either directly or after either or both of the following: a) conversion to another language, code or notation; b) reproduction in a different material form.

As shown above, the system enables efficient routing of documents within an organization. For example, a combined document file that includes electronic version of correspondences associated with a group of concerns, such as patent applications, may be downloaded from a data server. The documents in the combined document file may correspond to documents communicated in a certain date range.

A parsable data file that includes listing of documents associated with the concern may also be downloaded. The parsable data file may include information objects that define header information and document characterization information associated with the concerns. The header information may be utilized to identify an individual associated with a given concern. The document characterization information may be stored in a database and utilized to generate a message to the individual. A document from the combined document file that is associated with the document characterization information may be attached to the message. The message may then be communicated to the individual.

While the method and system has been described with reference to certain embodiments, it will be understood by those skilled in the art that various changes may be made and equivalents may be substituted without departing from the scope. In addition, many modifications may be made to adapt a particular situation or material to the teachings without departing from its scope. Therefore, it is intended that the present method and system not be limited to the particular embodiment disclosed, but that the method and system include all embodiments falling within the scope of the appended claims.

We claim:

1. A method for classifying documents comprising:
receiving, at an information server, a data file that defines information objects associated with a plurality of documents, wherein each of the information objects defines an ID and document characterization information;
parsing, by a processor of the information server, the data file to isolate an information object associated with a document;
determining, by the processor of the information server, a database record associated with the ID;
storing, by the processor, at least some of the document characterization information in the record.

2. The method according to claim 1, further comprising:
determining, by the record search logic of the information server, a user associated with the ID;
generating, by message generation logic of the information server, a communication that includes at least some of the document characterization information; and
communicating, by communication logic of the information server, the communication to the user.

3. The method according to claim 2, further comprising associating the document with the communication before communicating the communication to the user.

4. The method according to claim 1, wherein the data file corresponds to an extensible markup language (XML) data file.

5. The method according to claim 1, wherein the document corresponds to a file that includes a graphical image of a correspondence.

6. The method according to claim 5, wherein the file corresponds to a portable document format (PDF) file.

7. The method according to claim 1, further comprising:
flagging the information object for review when information defined by the record does not match information defined by the information object.

8. The method according to claim 1, further comprising:
receiving a combined document file that includes a plurality of documents, wherein the parsable data defines a plurality of information objects, each information object of the plurality of information object being associated with a document of the plurality of documents.

9. The method according to claim 8, further comprising extracting a document of the plurality of documents and associating the extracted document with the communication before communicating the communication to the user.

10. A system for routing document comprising:
an information server with a processor configured to receive a data file that defines information objects associated with a plurality of documents, wherein each of the information objects defines an ID and document characterization information;
parsing logic of the processor configured to parse the data file to isolate an information object associated with a document
record search logic of the processor configured to search for a database record associated with the ID;
record storage logic of the processor configured to store at least some of the document characterization information in the record.

11. The system according to claim 10, wherein the record search logic is configured to search for a user associated with the ID, and further comprising:
message generation logic configured to generate a communication that includes at least some of the document characterization information; and
communication logic configured to communicate the communication to the user.

12. The system according to claim 11, wherein the message generation logic is further configured to associate the document with the communication before the communication is communicated to the user.

13. The system according to claim 10, wherein the data file corresponds to an extensible markup language (XML) data file.

14. The system according to claim 10, wherein the document corresponds to a file that includes a graphical image of a correspondence.

15. The system according to claim 14, wherein the file corresponds to a portable document format (PDF) file.

16. The system according to claim 10, further comprising data comparison logic configured to flag the information object for review when information defined by the record does not match information defined by the information object.

17. The system according to claim 10, wherein the information server is further configured to receive a combined document file that includes a plurality of documents, wherein the parsable data defines a plurality of information objects, each information object of the plurality of information object being associated with a document of the plurality of documents.

18. The system according to claim 10, further comprising extraction logic configured to extract a document of the plurality of documents and associate the extracted document with the communication before the communication is communicated to the user.

19. A machine-readable storage medium having stored thereon a computer program comprising at least one code section for routing documents, the at least one code section being executable by a machine for causing the machine to perform acts of:
receiving a data file that defines an information objects associated with a plurality of documents, wherein each of the information objects defines an ID and document characterization information;
parsing the data file to isolate an information object associated with a document
determining a database record associated with the ID;
storing at least some of the document characterization information in the record.

20. The machine-readable storage medium according to claim 19, wherein the code is executable by the machine to cause the machine to:
determine a user associated with the ID;
generate a communication that includes at least some of the document characterization information; and
communicate the communication to the user.

21. The machine-readable storage medium according to claim 19, wherein the code is executable by the machine to cause the machine to associate the document with the communication before communicating the communication to the user.
